(19) United States
(12) Patent Application Publication
(10) Pub. No.: US 2007/0152373 A1
(43) Pub. Date: Jul. 5, 2007

(54) Method for fabricating high-strength golf club head parts

(76) Inventors: Chun-Shan Wang, Tainan Hsien (TW); Ya-Jen Huang, Tainan Hsien (TW); Chin-Tien Kuo, Tainan Hsien (TW); Kai-Jen Ko, Tainan Hsien (TW); Shih-Peng Yang, Tainan Hsien (TW); Yen-Chu Tan, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/322,556

(22) Filed: Jan. 3, 2006

(51) Int. Cl. B29C 45/00

(52) U.S. Cl. 264/322; 264/328.1; 264/331.11

(57) ABSTRACT

This invention provides a method for fabricating golf club head parts of high strength. At first, vapor grown carbon fibers (VGCF) with 3-D linkage structure is directly grown through a fluidized bed process. Then the VGCF in weight of less than 50 wt % is compounded with 50 wt %˜99 wt % thermoplastic resin or thermosetting resin so as to make a composite material. Thereafter, the composite material is injection-molded or compression-molded to form the golf club head parts with outstanding strength and modulus, light weight, low linear expansion coefficient and high vibration absorption.

### FIELD OF THE INVENTION

The present invention relates to a method for fabricating golf club head parts, and more particularly, to a method for fabricating high strength golf club head parts by molding composite materials containing vapor-grown carbon fibers (VGCF) with three-dimensional (3-D) linkage structure.

### BACKGROUND OF THE INVENTION

Currently, the development and improvement of golf club heads are limited to the material requirements of light weight and high strength, and thus have reached a bottleneck with regard to the manufacturing technique or material selection.

Referring to FIG. 1, for the consideration of strength, a conventional club head 1 is mainly made of an iron-based or titanium-based metal, wherein a plurality of parts (two parts 11 and 11′ are used herein for explanation) are formed by forging or casting, and then two parts (11 and 11′) are welded to form a hollow golf club head 1, thereby meeting the requirement of cutting the weight of the golf club head 1 without affecting the condition of strength.

However, the specific gravities of both iron-based and titanium-based metals are more than 4 g/cm³, and thus there is almost no extra room left for the conventional golf club head design to simultaneously achieve the objectives of strength enhancement and total weight cut by the conventional methods.

Currently, some club makers have used the conventional carbon fiber composite materials of low specific gravity (smaller than 4 g/cm³) as the materials for the golf club head 1 to improve the disadvantages of the iron-based or titanium-based metal used as the material thereof. The conventional carbon fiber composite materials currently used are generally prepregs of unidirectional carbon fiber filaments which do not have altitudinal (z-axial) strength, or chopped carbon fibers impregnated with thermosetting resins, wherein only the method of pressure bag molding or filament winding can only be used for forming the parts 11 and 11′ of the golf club head 1, which has higher manufacturing cost and is not suitable for mass production. Therefore, overall speaking, although the carbon fiber composite materials currently used for fabricating the parts 11 and 11′ have resolved the weight problem of the golf club head 1, yet it still needs improvements in the aspects of structural strength and mass production.

Hence, it is a goal for this industry to strive toward solving the aforementioned bottleneck for making the parts 11 and 11′ of the golf club head 1, thereby fabricating the golf club head parts 11 and 11′ of high strength and light weight with better efficiency and lower production cost.

### SUMMARY OF THE INVENTION

In one aspect, the present invention provides a method for fabricating golf club head parts by using a composite material of high strength and light weight, thereby effectively mass-producing the golf club head parts at low production cost with the features of light weight, low expansion coefficient, good shock-absorbing effect and high strength.

According to the aforementioned aspect, a method for fabricating high-strength golf club head parts is provided.

According to a preferred embodiment of the present invention, the method for fabricating golf club head parts comprises the following steps. At first, vapor-grown carbon fibers (VGCF) having a three-dimensional (3-D) linkage structure are grown directly through a fluidized bed process, and then the VGCF is mixed into a matrix made of thermosetting or thermoplastic resin, wherein the content of the VGCF is less than or equal to about 50 wt %, and the content of the matrix about 50 wt % and about 99 wt %. Thereafter, a method of injection molding or compression molding is used to fabricate the golf club head parts having the features of light weight, low expansion coefficient, good shock-absorbing effect and high strength.

The present invention is advantageous in using a low-cost mass production method different from the conventional fabrication method of golf club head parts to fabricate golf club head parts having the features of light weight, low expansion coefficient, good shock-absorbing effect and high strength.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic 3-D diagram showing a conventional golf club head composed of two parts;

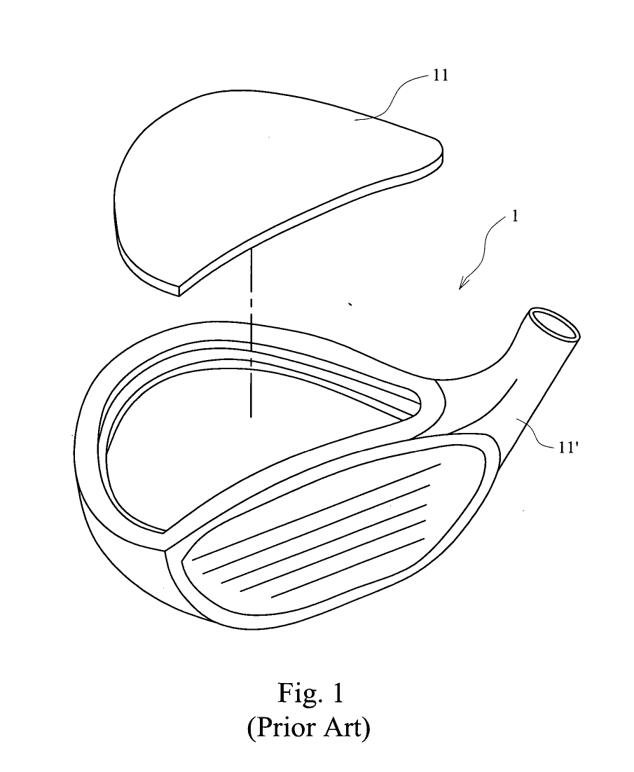

FIG. 2 is a flow chart showing a method for fabricating golf club head parts according to a preferred embodiment of the present invention; and

FIG. 3 is a SEM photograph (25000×) showing the VGCF having a 3-D linkage structure used in the present invention.

### DETAILED DESCRIPTION OF THE PREFERRED EMBODIMENT

Reference will now be made in detail to the present preferred embodiments of the invention, examples of which are illustrated in the accompanying drawings.

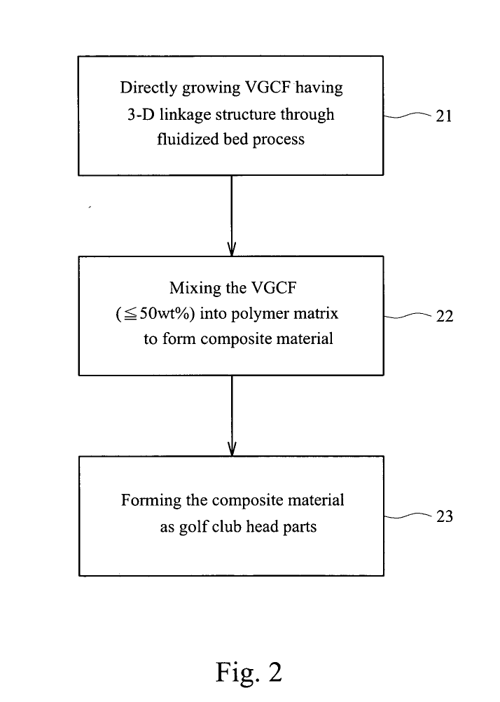

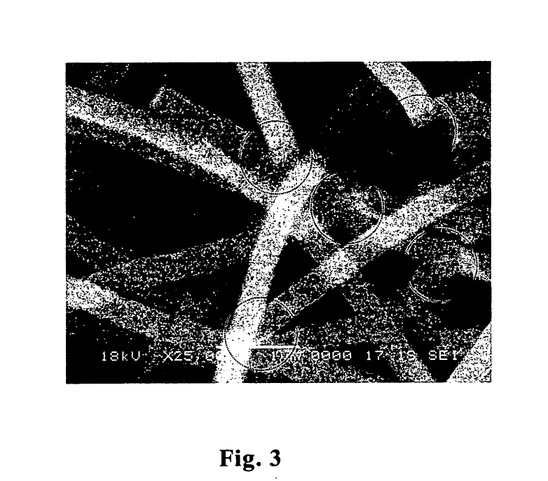

Referring to FIG. 2 and FIG. 3, in a preferred embodiment of the present invention, the method for fabricating golf club head parts is mainly to perform step 21 for directly growing VGCF having a 3-D linkage structure through fluidized bed process at first. During the process for forming the VGCF, the tubular reactor used therein is an upright aluminum oxide tube with an inner diameter of 70 mm, an outer diameter of 76 mm and a length of 1500 mm, and a xylene solution containing ferrocene, thiophene and aluminum isopropoxide is introduced to pass through the tubular reactor at a flow rate of about 12 ml/min under hydrogen atmosphere of from about 1100° C. to about 1200° C., and the xylene solution is pyrolyzed so as to directly grow the VGCF having the three-dimensional linkage structure. Such as shown in FIG. 3, the diameter of each of the VGCF is between about 20 nm and about 1000 nm, and the length of VGCF is substantially between 1 μm and 1000 μm, wherein the circled areas shown in FIG. 3 are the portions having the 3-D linkage structure.

Next, step 22 is performed for mixing the VGCF (≦50 wt %) into a polymer matrix to form composite material, wherein the content of the VGCF is preferably between about 1 wt % and 50 wt %, and the content of the polymer matrix is between about 50 wt % and 99 wt %. The polymer matrix can be a thermoplastic resin or a thermosetting resin, wherein the thermoplastic resin may be but not limited to such as acrylonitrile butadine styrene (ABS), polypropylene (PP), polyethylene terephthalate (PET), polycarbonate (PC), polyether ether ketone (PEEK), polyamide (Nylon), polystyrene (PS), polyphthalamide (PPA), or a combination thereof; and the thermosetting resin may be but not limited to such as epoxy resin, vinylester resin, phenolic resin, urea formaldehyde resin, unsaturated polyester resin, polyurethane resin or cyanate ester resin.

Thereafter, step 23 is performed for forming the composite material as the parts 11 and 11′ of the golf club head 1 by injection molding or compression molding.

Hereinafter, an enablement example made by using the method of the present invention for fabricating high-strength golf club head parts is compared with comparison examples for clearly showing the advantages of the present invention.

### Enablement Example

10 kg of the VGCF with 3-D linkage structure formed through the aforementioned fluidized bed process are taken and added in 30 kg of water, and then 100 g of dispersant (ENHOL DME-350 produced by En Hou Polymer Chemical Ind. Co., LTD., Taiwan) is added thereto, so as to form a mixture. After the mixture is ultrasonically shaken for four hours, the VGCF are filtered out from the mixture and dried in an oven.

57 kg of acrylonitrile butadine styrene (ABS) is used as a polymer matrix, and 57 g of zinc stearate is used as a lubricant. The ABS and the zinc stearate are mixed and then are fed into a twin-screws extruder via a main feeding zone thereof, and the dried VGCF described above are fed into the twin-screws extruder via a side feeding zone thereof for performing a kneading process, thereby obtaining a masterbach containing 15 wt % of the VGCF with 3-D linkage structure.

Further, 331 kg of ABS and the masterbach containing 15 wt % of the VGCF with 3-D linkage structure is kneaded in a single-screw extruder so as to form a composite material containing 5 wt % of the VGCF with 3-D linkage structure.

Thereafter, an injection molding machine is used for forming the composite material containing 5 wt % of the VGCF with 3-D linkage structure as the parts 11 and 11′ of the high-strength golf club head 1 by injection molding.

### Comparison Example 1

10 kg of the conventional linear VGCF (100 nm-300 nm in diameter; 5 μm-100 μm in length) are taken to replace the VGCF with 3-D linkage structure applied in the enablement example described above, wherein the rest steps of this comparison example is similar to those of the enablement example, thereby fabricating the golf club head parts containing 5 wt % of the conventional linear VGCF and having the same shape as the golf club head parts formed in the enablement example.

### Comparison Example 2

1.2 Kg of epoxy resin with EEW (epoxy equivalent weight) 800 and 0.0735 kg of diamino diphenyl methane are taken and fully dissolved in 3 kg of acetone so as to form a vanish. Then, carbon fiber cloth woven from the conventional PAN carbon fiber filaments is impregnated with the vanish so as to prepare a prepreg.

Thereafter, the prepreg is thermally pressed and cured with a series of process conditions, wherein the process conditions in sequence are under 130° C. for one hour; under 145° C. for two hours; and under 165° C. for three hour, thereby fabricating the golf club head parts having the same shape as the golf club head parts formed in the enablement example.

### Quality Tests

The respective composite materials forming the golf club head parts are taken from the enablement example, the comparison 1 and the comparison 2 described above, and used for fabricating three test plates respectively, wherein each of test plates is 4 inch long, 1 inch wide and 0.09 inch thick. Then, a three-points bend test is conducted on each of the test plates by using a downward force with 3.6 inch span at 0.1 inch/min, and the test results for the test plates are listed in the following table.

| | Appearance Inspection | Bending Strength (MPa) |
|---|---|---|
| Enablement example | pass | 30.2 |
| Comparison example 1 | pass | 26.8 |
| Comparison example 2 | pass | 20.1 |

According to the above test results, the test plate from the comparison example 1 adopting the composite material reinforced with the conventional linear VGCF only has the bending strength of 26.8 MPa. Although the z-axial strength may be reinforced via the conventional linear VGCF, yet the effect of strength reinforcement is limited.

The conventional PAN carbon fiber filaments adopted in the comparison example 2 do not have high z-axial strength, and the composite material formed therein is made by the conventional method of resin impregnation and lamination, so that lamination damage is easily to be caused while the composite material is under stress, and thus the test plate from the comparison example 2 only has the bending strength of 20.1 MPa.

The enablement example completed in accordance with the fabrication method of the present invention adopts the composite material formed by kneading the high-strength VGCF having the 3-D linkage structure with the polymer matrix. The VGCF having the 3-D linkage structure is isotropically distributed during the kneading process, so that the problem of insufficient z-axial strength can be resolved. Meanwhile, the shortcoming of the conventional carbon fibers also can be overcome, since the VGCF used in the present invention are high-strength carbon fibers with 3-D linkage structure. Thus, the test plate from the enablement example has the greatest bending strength of 30.2 MPa. As matter of fact, the composite material from the comparison example 2 is commonly used in the current industry for fabricating the golf club head parts.

The present invention forms the composite material by kneading the high-strength VGCF with 3-D structure uniformly with the polymer matrix. Since the composite material has the features of high elastic modulus, low expansion coefficient, high strength and low specific weight, the golf club head parts made thereof have the advantages of light weight, better shock-absorbing effect, small variance of process size and good product yield control. Meanwhile, when the golf club head parts from the present invention are assembled with other components, the assembled product is not susceptible to retaining residual stress and will has high interfacial strength.

Further, with respect to the production method, the conventional methods generally fabricate the golf club head parts with conventional carbon fiber composite material by bag molding or filament winding, and are not suitable for mass production. However, the composite material from the present invention can be processed by injection molding or compression molding for fabricating the golf club head parts, and is suitable for mass production, thus lowering production cost and actually the objectives of the present invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for fabricating golf club head parts, comprising:
directly growing vapor-grown carbon fibers (VGCF) having a three-dimensional (3-D) linkage structure through a fluidized bed process;
mixing said VGCF having said three-dimensional linkage structure uniformly into a polymer matrix so as to obtain a composite material, wherein the content of said VGCF is substantially less than or equal to 50 wt %; and
forming said composite material into said golf club head parts.

2. The method of claim 1, wherein said step of directly said VGCF having said three-dimensional linkage structure comprises:
introducing a xylene solution containing ferrocene, thiophene and aluminum isopropoxide to pass through an upright tubular reactor made of aluminum oxide substantially at a flow rate of 12 ml/min under hydrogen atmosphere of substantially from 1100° C. to 1200° C., thereby pyrolyzing said xylene solution containing ferrocene, thiophene and aluminum isopropoxide to prepare said VGCF having said three-dimensional linkage structure.

3. The method of claim 1, wherein the diameter of each of said VGCF is substantially between 20 nm and 1000 nm, and the length of each of said VGCF is substantially between 1 μm and 1000 μm.

4. The method of claim 2, wherein the diameter of each of said VGCF is substantially between 20 nm and 1000 nm, and the length of each of said VGCF is substantially between 1 μm and 1000 μm.

5. The method of claim 1, wherein said polymer matrix is a thermoplastic resin, and the content of said polymer matrix is substantially between 50 wt % and 99 wt %.

6. The method of claim 5, wherein said thermoplastic resin is selected from the group consisting of acrylonitrile butadine styrene (ABS), polypropylene (PP), polyethylene terephthalate (PET), polycarbonate (PC), polyether ether ketone (PEEK), polyamide (Nylon), polystyrene (PS), polyphthalamide (PPA), and a combination thereof.

7. The method of claim 1, wherein said polymer matrix is a thermosetting resin, and the content of said polymer matrix is substantially between 50 wt % and 99 wt %.

8. The method of claim 1, wherein said thermosetting resin is selected from the group consisting of epoxy resin, vinylester resin, phenolic resin, urea formaldehyde resin, unsaturated polyester resin, polyurethane resin and cyanate ester resin.

9. The method of claim 1, wherein said step of forming said composite material into said golf club head parts is performed by injection molding.

10. The method of claim 1, wherein said step of forming said composite material into said golf club head parts is performed by compression molding.
